(19) United States
(12) Patent Application Publication
(10) Pub. No.: US 2025/0315574 A1
(43) Pub. Date: Oct. 9, 2025

(54) AXIAL FLUX MOTOR DESIGN VARIABLE VERIFICATION METHOD AND AXIAL FLUX MOTOR DESIGN VARIABLE OPTIMIZATION METHOD

(71) Applicant: UIF (University Industry Foundation), Yonsei University, Seoul (KR)

(72) Inventors: Jun Young YOON, Seoul (KR); Jong Min SUNG, Seoul (KR); Jae Hyun KIM, Incheon (KR); Sang Min LEE, Seoul (KR); Bo Min KANG, Seoul (KR); Jeong Min PARK, Seoul (KR); Byung Wook JEON, Seoul (KR); Kang Hee LEE, Seoul (KR); Jae Heon JUNG, Seoul (KR)

(73) Assignee: UIF (University Industry Foundation), Yonsei University, Seoul (KR)

(21) Appl. No.: 19/098,118

(22) Filed: Apr. 2, 2025

(30) Foreign Application Priority Data
Apr. 8, 2024 (KR) 10-2024-0047470

(51) Int. Cl. G06F 30/23; G06F 111/10; G06F 119/14

(52) U.S. Cl. CPC G06F 30/23; G06F 2111/10; G06F 2119/14

(57) ABSTRACT

The method for verifying the axial flux motor design variable includes: a first step of converting a cylindrical coordinate system design variable of the axial flux motor into an orthogonal coordinate system design variable; a second step of deriving a orthogonal coordinate system magnetic field from the orthogonal coordinate system design variable; a third step of deriving a cylindrical coordinate system magnetic field from the derived orthogonal coordinate system magnetic field; a fourth step of deriving one or more verification target physical quantities selected from a group consisting of magnetic flux linkage, counter electromotive force, inductance, and torque from the cylindrical coordinate system magnetic field; and a fifth step of comparing the verification target physical quantity with a predetermined reference value and determining whether a verification condition thereon is achieved, based on the comparing result.

### CROSS-REFERENCE TO RELATED APPLICATION(S)

This application claims the benefit under 35 USC 119(a) of Korean Patent Application No. KR 10-2024-0047470, filed on Apr. 8, 2024, with the Korean Intellectual Property Office, the disclosure of which is incorporated herein by reference in its entirety.

### BACKGROUND

### Field

The present disclosure relates to a method for verifying an axial flux motor design variable and a method for optimizing an axial flux motor design variable. Specifically, the present disclosure relates to a method for verifying a motor design variable by converting an electromagnetic characteristic resulting from a three-dimensional shape of an axial flux motor into an orthogonal coordinate system, and optimization of a motor design variable according to such a coordinate conversion analysis method.

### Description of Related Art

An actuator mounted on a mobility apparatus should achieve high thrust and efficiency while minimizing a weight and a volume thereof. In accordance with the above needs of the industries, an axial flux motor having a higher density of force than a radial flux motor is attracting attention. The axial flux motor is a motor in which a magnetic field flows around a rotation axis, and a magnetic flux flows in an axial direction. Such a structure makes it possible to achieve high efficiency and torque density while reducing the size of the motor. In particular, the axial flux motor is suitable for electric vehicles, drones, etc. that require weight reduction and high efficiency.

In order to maximize the density of force, the axial flux motor introduces an iron core capable of concentrating the magnetic flux thereto. This causes unwanted force waves, three-dimensional magnetic field effects, core loss, etc. Therefore, in order to design an efficient iron core axial flux motor, it was necessary to consider these limitations in the early stages of motor design, and the need for a method to predict and verify electromagnetic properties according to motor design variables was highlighted.

Conventionally, there have been many techniques for calculating the magneto-static field maxwell equation in a form of a simultaneous partial differential equation as a dominant equation in electromagnetic problems, via numerical calculations such as finite element method. In the motor analysis using such a numerical calculation method, the structural shape of the motor needs to be divided into a large number of nodes and meshes, such that there is a problem in that the analysis takes a lot of time when the calculation is performed while changing the design variables in various ways.

The approach in which the iron core axial flux motor is modeled directly in the three-dimensional cylindrical coordinate system may be considered. However, in this approach, it is very difficult to set up and solve the Maxwell electromagnetic equation on the three-dimensional cylindrical coordinate system in consideration of all conditions such as a change in magnetic permeability caused by the iron core, an atypical iron core, and the shape of a permanent magnet, and a high-dimensional mathematical concept should be introduced. Due to these difficulties, no perfect three-dimensional analytical modeling technology exists to date.

### SUMMARY

In order to overcome such problems of the prior art, the present disclosure provides a novel analysis technique which simplifies the difficulty of three-dimensional modeling research by converting a cylindrical coordinate system of an iron core axial flux motor into a three-dimensional orthogonal coordinate system, secures the three-dimensional magnetic field effect and the degree of freedom related to the atypical shape, and enables the task of predicting the electromagnetic characteristics of the iron core axial flux motor in a prototype stage to be quickly performed. In the present disclosure, the iron core axial flux motor is set forth by way of example. However, the present disclosure is not necessarily limited to the iron core.

A purpose to be achieved by the present disclosure is to find a method for reducing complexity and time consumption that may occur in the design process of an axial flux motor, and at the same time maximizing the performance of the motor. In this process, the analysis and optimization method proposed by the present disclosure may help the designer to efficiently adjust and predict various design variables. This may also enable rapid prototyping and testing, thereby shortening the development cycle and helping to respond quickly to the market. In addition, the method of the present disclosure has the potential to contribute to the development of innovative motor design and application fields by allowing the advanced motor design technology to be accessible to a wider range of designers and researchers.

A first aspect of the present disclosure provides a method for verifying an axial flux motor design variable, the method comprising: a first step of converting a following equation (1) about a cylindrical coordinate system design variable of the axial flux motor into an orthogonal coordinate system design variable using a following equation (2); a second step of deriving a orthogonal coordinate system magnetic field from the orthogonal coordinate system design variable; a third step of deriving a cylindrical coordinate system magnetic field from the derived orthogonal coordinate system magnetic field using the following equation (2) in an inverse manner; a fourth step of deriving one or more verification target physical quantities selected from a group consisting of magnetic flux linkage, counter electromotive force, inductance, and torque from the cylindrical coordinate system magnetic field; and a fifth step of comparing the verification target physical quantity with a predetermined reference value and determining whether a verification condition thereon is achieved, based on the comparing result:

$${G}_{P M} ( r , θ ) = \{ \begin{matrix}1 & ( PM existing point ) \\ 0 & ( otherwise )\end{matrix} \qquad ( 1 )$$

$$( {x}_{T} , {y}_{T} ) = ( {tan}^{- 1} ( \frac{x}{y} ) {R}_{c} , \sqrt{{x}^{2} + {y}^{2}} ) \qquad ( 2 )$$

where G is a cylindrical coordinate system design variable based on a radial distance and an angle, r is the radial distance, ƒ is a cylindrical coordinate system angle, PM is a permanent magnet, R_{c} is a conversion reference radius.

In accordance with some embodiments of the axial flux motor design variable verification method, the second step includes deriving the orthogonal coordinate system magnetic field from the orthogonal coordinate system design variable using a following equation (3):

$$∇ \cdot B = 0 \\ ∇ \times H = J \qquad ( 3 )$$

where B is magnetic flux density, H is a magnetic field strength, J is a current density of a stator.

In accordance with some embodiments of the axial flux motor design variable verification method, the magnetic flux linkage is derived based on a following equation (4):

$$∅ = \int B \cdot dA = \int ( ∇ \times A ) \cdot dA = ∮ A \cdot dl \qquad ( 4 )$$

where Φ is magnetic flux, B is magnetic flux density, A is a magnetic vector potential, ∇×A is a magnetic vector potential curl.

In accordance with some embodiments of the axial flux motor design variable verification method, the counter electromotive force is derived based on a following equation (5):

$$ε = - \frac{d ∅}{dt} = - \frac{d ∅}{{dy}_{r}} \frac{{dy}_{r}}{dt} = - v \frac{d ∅}{{dy}_{r}} \qquad ( 5 )$$

where ε is the counter electromotive force, t is a time, yᵣ is a movement distance, v is a velocity of a mover of the axial flux motor.

In accordance with some embodiments of the axial flux motor design variable verification method, the inductance is derived based on the following equation (6):

$$L = ∅ I \qquad ( 6 )$$

where L denotes inductance of a stator of the axial flux motor, I is a magnitude of current applied to the stator of the axial flux motor.

In accordance with some embodiments of the axial flux motor design variable verification method, the torque is derived based on a following equation (7):

$$τ = {\int }_{{R}_{i}}^{{R}_{o}} {\int }_{- \frac{{θ}_{u}}{2}}^{\frac{{θ}_{u}}{2}} \frac{{B}_{θ} ( r , θ ) {B}_{z} ( {r}^{′} θ )}{{μ}_{0}} \cdot \hat{r} \cdot rdrd θ \approx {\sum }_{i = 1}^{M} {\sum }_{j = 1}^{N} \frac{{B}_{ij , θ} {B}_{ij , z}}{{μ}_{0}} \cdot \hat{{r}_{i}} \cdot {r}_{i} \frac{{θ}_{u}}{N} \frac{{R}_{o} - {R}_{i}}{M} \qquad ( 7 )$$

where τ is the torque, r is a radius as a variable, Rₒ is an outer radius as a constant, Rᵢ is an inner radius as a constant, θᵤ is a length in an angular direction of the axial flux motor as a constant, a subscript i is a position index in a radial direction, a subscript j is a position index in an angular direction, M is the number of lattices in a radial direction in a motor coordinate system, N is the number of lattices in an angular direction in a motor coordinate system.

A second aspect of the present disclosure provides a method for optimizing an axial flux motor design variable, the method comprising: a first step of converting a following equation (1) about each cylindrical coordinate system design variable of each of two or more virtual axial flux motors into each orthogonal coordinate system design variable using a following equation (2); a second step of deriving each orthogonal coordinate system magnetic field from each orthogonal coordinate system design variable; a third step of deriving each cylindrical coordinate system magnetic field from each derived orthogonal coordinate system magnetic field using a following equation (2) in an inverse manner; a fourth step of deriving each of one or more verification target physical quantities selected from the group consisting of magnetic flux linkage, counter electromotive force, inductance, and torque from each derived cylindrical coordinate system magnetic field; and a fifth step of comparing each derived verification target physical quantity with a target design value, and selecting the virtual linear motor having the verification target physical quantity satisfying a target verification condition of the design variable among the two or more virtual axial flux motors, based on the comparing result, wherein the method further comprises repeating the first to fifth steps at least one time on two or more virtual axial flux motors including the virtual axial flux motor selected in the fifth step:

$${G}_{P M} ( r , θ ) = \{ \begin{matrix}1 & ( PM existing point ) \\ 0 & ( otherwise )\end{matrix} \qquad ( 1 )$$

$$( {x}_{T} , {y}_{T} ) = ( {tan}^{- 1} ( \frac{x}{y} ) {R}_{c} , \sqrt{{x}^{2} + {y}^{2}} ) \qquad ( 2 )$$

where G is a cylindrical coordinate system design variable based on a radial distance and an angle, r is the radial distance, θ is a cylindrical coordinate system angle, PM is a permanent magnet, R_{c} is a conversion reference radius.

In accordance with some embodiments of the axial flux motor design variable optimization method, the second step includes deriving the orthogonal coordinate system magnetic field from the orthogonal coordinate system design variable using a following equation (3):

$$∇ \cdot B = 0 ∇ \times H = J \qquad ( 3 )$$

where B is magnetic flux density, H is a magnetic field strength, Jis a current density of a stator.

In accordance with some embodiments of the axial flux motor design variable optimization method, the magnetic flux linkage is derived based on a following equation (4):

$$∅ = \int B \cdot dA = \int ( ∇ \times A ) \cdot dA = ∮ A \cdot dl \qquad ( 4 )$$

where Φ is magnetic flux, B is magnetic flux density, A is a magnetic vector potential, ∇×A is a magnetic vector potential curl.

In accordance with some embodiments of the axial flux motor design variable optimization method, the counter electromotive force is derived based on a following equation (5):

$$ε = - \frac{d ∅}{dt} = - \frac{d ∅}{{dy}_{r}} \frac{{dy}_{r}}{dt} = - v \frac{d ∅}{{dy}_{r}} \qquad ( 5 )$$

where ϑis the counter electromotive force, t is a time, yᵣ is a movement distance, v is a velocity of a mover of the axial flux motor.

In accordance with some embodiments of the axial flux motor design variable optimization method, the inductance is derived based on the following equation (6):

$$L = ∅ I \qquad ( 6 )$$

where L denotes inductance of a stator of the axial flux motor, I is a magnitude of current applied to the stator of the axial flux motor.

In accordance with some embodiments of the axial flux motor design variable optimization method, the torque is derived based on a following equation (7):

$$τ = {\int }_{{R}_{i}}^{{R}_{o}} {\int }_{- \frac{{θ}_{u}}{2}}^{\frac{{θ}_{u}}{2}} \frac{{B}_{θ} ( r , θ ) {B}_{z} ( {r}^{′} θ )}{{μ}_{0}} \cdot \hat{r} \cdot rdrd θ \approx {\sum }_{i = 1}^{M} {\sum }_{j = 1}^{N} \frac{{B}_{ij , θ} {B}_{ij , z}}{{μ}_{0}} \cdot \hat{{r}_{i}} \cdot {r}_{i} \frac{{θ}_{u}}{N} \frac{{R}_{o} - {R}_{i}}{M} \qquad ( 7 )$$

where τ is the torque, r is a radius as a variable, Rₒ is an outer radius as a constant, Rᵢ is an inner radius as a constant, θᵤ is a length in an angular direction of the axial flux motor as a constant, a subscript i is a position index in a radial direction, a subscript j is a position index in an angular direction, M is the number of lattices in a radial direction in a motor coordinate system, N is the number of lattices in an angular direction in a motor coordinate system.

The method of the present disclosure enables motor analysis with an accuracy of 95% or greater on a commercial finite element analysis program by utilizing an analytical solution of the magneto-static maxwell equation in the three-dimensional orthogonal coordinate system. In addition, since the method of the present disclosure does not require a process of dividing the structure of the motor to be analyzed into nodes and elements, it is possible to significantly reduce the time required for analysis compared to a commercial finite element analysis program. Using the high-speed electromagnetic analysis method of the present disclosure, there is an effect that it is possible to design a motor more quickly while maintaining the accuracy of the design method using a finite element analysis program based on the conventional numerical calculation method.

In addition, a solution of the cylindrical coordinate system and a solution of the orthogonal coordinate system are connected to each other via the method of the present disclosure, such that the possibility of breaking down the boundary between the axial flux motor (cylindrical) and the linear motor (rectangular parallelepiped), whose studies have been independently conducted in the past, and of applying technologies of the two fields complementarily is achieved. The iron core axial flux motor has many advantages compared to other motors, but the development history thereof is relatively short, so that the technical maturity thereof has not reached completion, and thus the iron core axial flux motor has not yet been popularly commercialized due to process difficulty, cost, and reliability reasons. When a linear motor optimization technology with relatively high reliability and many verified cases may be applied to the axial flux motor according to the possibility as suggested above in accordance with the present disclosure, the maturity of the axial flux motor technology may be added and commercialization thereof may be accelerated.

Specifically, the method of the present disclosure may provide flexibility of analyzing the electromagnetic characteristics both in a no-load state in which the motor does not operate and in an on-load state in which the motor is operating, using the magnetic vector potential in the analysis process. This may be of great help in predicting and optimizing the performance of the motor under various operating conditions. In addition, introducing the concept of a magnetic permeability matrix may allow for accurately calculating the electromagnetic characteristics not only of an air core type motor but also of an iron core type motor, thereby greatly expanding the range of the motor design. The method of using the lattice matrix on the shapes of iron cores and permanent magnets enables the electromagnetic characteristics to be calculated on motors using rectangular and circular magnets as well as on the magnets having a fan shape, thereby providing the possibility that a designer may experiment with more diverse motor shapes and magnet configurations and derive an optimal motor design.

In addition to the effects as described above, specific effects in accordance with the present disclosure will be described together with following detailed descriptions for carrying out the disclosure.

### BRIEF DESCRIPTION OF DRAWINGS

FIG. 1 is a diagram for illustrating the concept of a conversion reference radius used in the present disclosure.

FIG. 2 is a diagram showing a state in which a shape of the iron core axial direction motor according to the present disclosure has been converted.

FIG. 3 is a diagram illustrating a conversion process in a coordinate system.

FIG. 4 shows a block diagram illustrating an electromagnetic analysis model according to the present disclosure.

FIG. 5 illustrates an example of a motor according to an embodiment of the present disclosure.

### DETAILED DESCRIPTIONS

Advantages and features of the present disclosure, and a method of achieving the advantages and features will become apparent with reference to embodiments described later in detail together with the accompanying drawings. However, the present disclosure is not limited to the embodiments as disclosed under, but may be implemented in various different forms. Thus, these embodiments are set forth only to make the present disclosure complete, and to completely inform the scope of the present disclosure to those of ordinary skill in the technical field to which the present disclosure belongs, and the present disclosure is only defined by the scope of the claims.

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for illustrating embodiments of the present disclosure are illustrative, and the present disclosure is not limited thereto.

The terminology used herein is directed to the purpose of describing particular embodiments only and is not intended to be limiting of the present disclosure. As used herein, the singular constitutes “a” and “an” are intended to include the plural constitutes as well, unless the context clearly indicates otherwise. It will be further understood that the terms “comprise”, “comprising”, “include”, and “including” when used in the present disclosure, specify the presence of the stated features, integers, operations, elements, and/or components, but do not preclude the presence or addition of one or more other features, integers, operations, elements, components, and/or portions thereof.

In interpreting a numerical value, the value is interpreted as including an error range unless there is no separate explicit description thereof. In the context of the present disclosure, the term “about” may mean about ±1%, about ±2%, about ±3%, about ±4%, about ±5%, about ±6%, about ±7%, about ±8%, about ±9%, or about ±10% of a value stated herein.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The terms used in the description as set forth below have been selected as being general and universal in the related technical field. However, there may be other terms than the terms depending on the development and/or change of technology, convention, preference of technicians, etc. Therefore, the terms used in the description as set forth below should not be understood as limiting technical ideas, but should be understood as examples of the terms for illustrating embodiments.

Further, in a specific case, a term may be arbitrarily selected by the applicant, and in this case, the detailed meaning thereof will be described in a corresponding description period. Therefore, the terms used in the description as set forth below should be understood based on not simply the name of the terms, but the meaning of the terms and the contents throughout the Detailed Descriptions.

A method for verifying an axial flux motor design variable according to an embodiment of the present disclosure includes: a first step of converting a following equation (1) about a cylindrical coordinate system design variable of the axial flux motor into an orthogonal coordinate system design variable using a following equation (2); a second step of deriving a orthogonal coordinate system magnetic field from the orthogonal coordinate system design variable; a third step of deriving a cylindrical coordinate system magnetic field from the derived orthogonal coordinate system magnetic field using the following equation (2) in an inverse manner; a fourth step of deriving one or more verification target physical quantities selected from a group consisting of magnetic flux linkage, counter electromotive force, inductance, and torque from the cylindrical coordinate system magnetic field; and a fifth step of comparing the verification target physical quantity with a predetermined reference value and determining whether a verification condition thereon is achieved, based on the comparing result:

$${G}_{PM} ( r , θ ) = \{ \begin{matrix}1 ( PM existing point ) \\ 0 ( otherwise )\end{matrix} \qquad ( 1 )$$

$$( {x}_{T} , {y}_{T} ) = ( {tan}^{- 1} ( \frac{x}{y} ) {R}_{c} , \sqrt{{x}^{2} + {y}^{2}} ) \qquad ( 2 )$$

where G is a cylindrical coordinate system design variable based on a radial distance and an angle, r is the radial distance, θ is a cylindrical coordinate system angle, PM is a permanent magnet, R_{c} is a conversion reference radius.

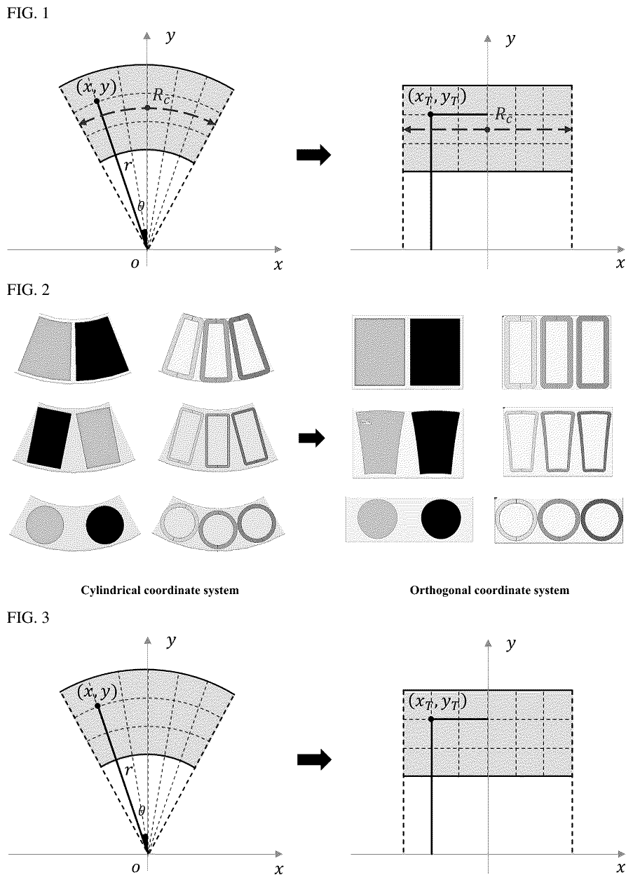

FIG. 1 is a diagram for illustrating the concept of a conversion reference radius used in the present disclosure. Referring to FIG. 1, in the context of the present disclosure, the meaning of the conversion reference radius R_{c} may be a reference radius value used when converting a position in a cylindrical coordinate system into a position in a orthogonal coordinate system. This radius value is used as a constant for mapping each point of the cylindrical coordinate system to an appropriate position in the transformed orthogonal coordinate system. Thus, the coordinates of all components including the position of the permanent magnet, which is an important element in the design of the motor, may be accurately converted from the cylindrical coordinate system into the orthogonal coordinate system.

The first step is performed by generating a binary lattice matrix indicating the position of the permanent magnet such that a value of 1 is allocated to the lattice indicating the position of the permanent magnet in the motor and a value of 0 is allocated to the lattice not indicating the position of the permanent magnet in the motor. Subsequently, the design information based on the cylindrical coordinate system is reconstructed so as to be suitable for the orthogonal coordinate system via coordinate conversion, thereby reducing the complexity of the analysis and shortening the time in the analysis process. The data obtained through this conversion is directly used for magnetic field calculations, including the current density of the stator. This plays an important role in increasing the accuracy of the overall motor design process.

In the context of the present disclosure, the meaning of the design variable refers to various factors considered when designing a motor. These variables may affect the performance, efficiency, size, cost, etc. of the motor. Using the method of the present disclosure, a motor designer may easily adjust these variables and analyze their effects, thereby improving the design process and helping to develop a motor suitable for a specific application. In particular, fine-tuning elements directly affecting the electromagnetic properties of the motor, for example, magnetic flux density, the number of windings of a coil, the arrangement of permanent magnets, etc. may be adjusted such that the efficiency of the motor may be optimized and a desired performance target may be obtained.

In the context of the present disclosure, each of the cylindrical coordinate system and the orthogonal coordinate system mean a coordinate system used to mathematically express the shape and electromagnetic characteristics of the motor. The cylindrical coordinate system is suitable for naturally expressing the circular structure of the motor, and uses the angle and distance around the axis as variables. On the other hand, the orthogonal coordinate system may be used to simplify the design and analysis of the motor, and represents a space using orthogonal coordinates such as x, y, and z.

Using the binary lattice matrix of the equation (1) as set forth above, not only circular but also rectangular and various shapes of magnets may be represented. It indicates the presence or absence of a magnet in the polar coordinate system based on the angle θ and the radial distance r. This is configured in such a way that a value of 1 is allocated to the coordinate where the magnet is located and a value of 0 is allocated to the coordinate in which the magnet is absent. This lattice matrix is applied to the Maxwell electromagnetic equation to enable magnetic field analysis based on the influence of the shape and distribution of magnets on motor design. This may provide a deeper understanding and prediction of the performance characteristics of the motor. This approach may be very useful in modeling important magnetic properties in the design of complex shapes of motors.

The second step includes a process of calculating the magnetic field of the motor in the converted orthogonal coordinate system. The magnetic field calculated in this process is used to quantify the electromagnetic phenomenon that interacts with various structural characteristics inside the motor. This numerical magnetic field information is used as an important basis for predicting the main electromagnetic characteristics of the motor, such as magnetic flux, counter electromotive force, inductance, and torque. These prediction may provide useful references in making important design decisions in the early stages of motor design, and may contribute to accelerating the development process and improving the accuracy of the design.

In the second step, the orthogonal coordinate system magnetic field may be derived from the orthogonal coordinate system design variable using a following equation (3):

$$∇ \cdot B = 0 \\ ∇ \times H = J \qquad ( 3 )$$

where B may be the magnetic flux density, H may be the magnetic field strength, and J may be the current density of the stator.

In the context of the present disclosure, the meaning of the current density of the stator indicates the intensity at which the current flows through the unit area. This is used to determine the distribution and density of the current passing through the stator coil, and is an important variable that directly affects the distribution and strength of the magnetic field in the motor. Therefore, accurately calculating and modeling the current density of the stator may help precisely predict and optimize the electromagnetic characteristics of the axial flux motor. J is the current density that indicates how dense the current flows in each part of the stator, and is a very important factor in motor design. The amount and distribution of the current passing through a specific part of the stator act as a major factor in determining the electromagnetic characteristics of the motor, and thus may ultimately affect the performance, efficiency, and heat generation of the motor.

The third step includes a process of inversely converting the magnetic field result derived from the orthogonal coordinate system into the cylindrical coordinate system. This conversion reconstructs the magnetic field analysis result so as to comply with the design characteristics of the axial flux motor having the natural shape of the cylindrical coordinate system, so that the actual electromagnetic conditions that the motor will experience in the actual operating environment may be applied. Physical quantities such as magnetic flux linkage, counter electromotive force, inductance, and torque obtained through this process may help not only to verify the performance of the motor, but also to derive design improvement points. Based on the comparing result of this information to a reference value, a designer may quantitatively determine whether a motor may achieve a particular performance target, and utilize the determination result to identify the item to be changed in the design and change the same if necessary.

The fourth step includes a process of numerically calculating actual operating characteristics of the motor. In this process, the physical quantities such as magnetic flux linkage, counter electromotive force, inductance, and torque which are electrical elements of the motor are calculated based on the magnetic field of the cylindrical coordinate system. The results obtained through these calculations are indicators directly representing the performance of the motor, and provide important data for evaluating the validity of the design via comparative analysis with the target value set in the design process. This analysis may optimize the performance of the motor, provide useful feedback in achieving the design goals, and lay the foundation for gradually improving the performance of the motor via iterative design-test cycles if necessary.

In one embodiment, the magnetic flux linkage may be derived based on the following equation (4):

$$∅ = \int B \cdot dA = \int ( ∇ \times A ) \cdot dA = ∮ A \cdot dl \qquad ( 4 )$$

where Φ is magnetic flux, B is magnetic flux density, A is a magnetic vector potential, ∇×A is a magnetic vector potential curl.

In the above equation (4), the second item represents the integral of the magnetic flux density passing through the closed curved surface, and the third item represents the magnetic flux as the surface integral via rotation of the magnetic vector potential. Thus, the magnetic flux linkage may be obtained by integrating the magnetic vector potential along the closed curve in the fourth item.

In the context of the present disclosure, the meaning of the magnetic flux linkage represents the total sum of magnetic flux along the closed path in the magnetic field, which may be calculated using the magnetic vector potential. In the context of the present disclosure, the meaning of the magnetic flux indicates the amount of the magnetic field passing through a specific area, and may be calculated via a vector product of the strength of the magnetic field and the area. In the context of the present disclosure, the meaning of the magnetic flux density represents the amount of magnetic flux per unit area, which is mainly expressed as Tesla (T). In the context of the present disclosure, the meaning of the magnetic vector potential is a vector function based on a position in a magnetic field, which enables the magnetic field to be expressed as a rotation of a vector field. In the context of the present disclosure, the meaning of the magnetic vector potential curl is a vector representing the direction and magnitude of the magnetic field at a given point. This value describes the change in the magnetic field in a space and may be used to connect the presence and distribution of current to each other.

The use of the magnetic vector potential suggests a method that may comprehensively consider the change in electromagnetic properties of the motor depending on whether a current is applied or not. Thus, it is possible to determine the distribution of the magnetic field according to the presence or absence of a current in the motor and the influence thereof. In particular, in a no-load condition in which the current is not applied, interpretation is performed in consideration of only the magnetic flux distribution of the magnet while ignoring the current density, whereas in an on-load condition in which the current is applied, more complex magnetic field interactions including the current density are modeled.

In one embodiment, the counter electromotive force may be derived based on the following equation (5):

$$ε = - \frac{d ∅}{dt} = - \frac{d ∅}{{dy}_{r}} \frac{{dy}_{r}}{dt} = - v \frac{d ∅}{{dy}_{r}} \qquad ( 5 )$$

where ε is a counter electromotive force, t is a time, yᵣ is a movement distance, and v is a velocity of a mover of the axial flux motor.

The counter electromotive force ε represents a voltage induced by a magnetic flux change rate. In this regard, the rate of change of the magnetic flux Φ based on the time t is associated with the movement distance yᵣ and is changed based on the velocity v of a mover of the axial flux motor. This is a process of observing a change in a magnetic field according to a motion state of a motor and converting the change into an electrical signal. Through these calculations, useful information for estimating the motor's output and developing the control algorithm may be provided.

In an embodiment, the inductance may be derived based on the following equation (6):

$$L = ∅ I \qquad ( 6 )$$

where L denotes inductance of a stator of the axial flux motor, I is a magnitude of current applied to the stator of the axial flux motor.

The inductance L may be expressed as the product of the magnetic flux Φ and the current I. The inductance is a physical value that measures the system's response to a change in current, and represents the influence of the magnetic field generated by current inside the stator of an axial flux motor. Through this value, the magnetic energy storage ability of the motor according to the current change may be identified, which may be an important indicator in motor design and performance evaluation.

In an embodiment, the torque may be derived based on the following equation (7):

$$τ = {\int }_{{R}_{i}}^{{R}_{o}} {\int }_{- \frac{{θ}_{u}}{2}}^{\frac{{θ}_{u}}{2}} \frac{{B}_{θ} ( r , θ ) {B}_{z} ( {r}^{′} θ )}{{μ}_{0}} \cdot \hat{r} \cdot rdrd θ \approx {\sum }_{i = 1}^{M} {\sum }_{j = 1}^{N} \frac{{B}_{ij , θ} {B}_{ij , z}}{{μ}_{0}} \cdot \hat{{r}_{i}} \cdot {r}_{i} \frac{{θ}_{u}}{N} \frac{{R}_{o} - {R}_{i}}{M} \qquad ( 7 )$$

where τ is the torque, ris a radius as a variable, Rₒ is an outer radius as a constant, Rᵢ is an inner radius as a constant, θᵤ is a length in an angular direction of the axial flux motor as a constant, a subscript i is a position index in a radial direction, a subscript j is a position index in an angular direction, M is the number of lattices in a radial direction in a motor coordinate system, and N is the number of lattices in an angular direction in a motor coordinate system.

Through the equation (7) as set forth above, the torque τ may be calculated based on the magnetic field interaction between the stator and the rotor of the axial flux motor. This equation approximately represent the torque via interaction between the angular distribution B_{θ}(r, θ) of the magnetic field vector and the height direction component B_{z}(r, θ) of the magnetic field vector, and the equation is based on the length θᵤ in an angular direction of the axial flux motor, the number M of lattices in a radial direction in a motor coordinate system, and the number N of lattices in an angular direction in a motor coordinate system. This calculation may help understand and optimize the effect of structural and magnetic design variables of the motor on the final torque output.

The second item of the equation (7) is a process of integrating the magnetic field to obtain the torque, and the third item of the equation is a process of approximating the derived magnetic field in the form of a sum of the integral of the derived magnetic field because the derived magnetic field is discrete. Since the magnetic field B used in the equation (7) is a solution of the Maxwell equation in which the magnetic permeability matrix is already applied, the magnetic permeability matrix is not directly expressed in the equation (7). However, the method of the present disclosure applies the concept of the magnetic permeability matrix, so that electromagnetic characteristics of the iron core type motor as well as the slotless or air-cored motor may be calculated.

The fifth step includes a process of evaluating whether the design goal of the axial flux motor is satisfied based on the physical quantity derived in the previous step. Physical values such as magnetic flux linkage, counter electromotive force, inductance, and torque obtained in this process are compared with predefined reference values to examine the validity of motor design. If each of these physical quantities does not meet the corresponding reference value, this may be interpreted as a signal indicating that further adjustment on the motor design is needed. This verification process may enable fine adjustment of motor design, thereby helping to eventually lead to more efficient and reliable motor development.

In another aspect, ta method for optimizing an axial flux motor design variable according to an embodiment of the present disclosure includes: a first step of converting a following Equation (1) about each cylindrical coordinate system design variable of each of two or more virtual axial flux motors into each orthogonal coordinate system design variable using a following Equation (2); a second step of deriving each orthogonal coordinate system magnetic field from each orthogonal coordinate system design variable; a third step of deriving each cylindrical coordinate system magnetic field from each derived orthogonal coordinate system magnetic field using a following Equation (2) in an inverse manner; a fourth step of deriving each of one or more verification target physical quantities selected from the group consisting of magnetic flux linkage, counter electromotive force, inductance, and torque from each derived cylindrical coordinate system magnetic field; and a fifth step of comparing each derived verification target physical quantity with a target design value, and selecting the virtual linear motor having the verification target physical quantity satisfying a target verification condition of the design variable among the two or more virtual axial flux motors, based on the comparing result, wherein the method further comprises repeating the first to fifth steps at least one time on two or more virtual axial flux motors including the virtual axial flux motor selected in the fifth step:

$${G}_{PM} ( r , θ ) = \{ \begin{matrix}1 ( PM existing point ) \\ 0 ( otherwise )\end{matrix} \qquad ( 1 )$$

$$( {x}_{T} , {y}_{T} ) = ( {tan}^{- 1} ( \frac{x}{y} ) {R}_{c} , \sqrt{{x}^{2} + {y}^{2}} ) \qquad ( 2 )$$

where G is a cylindrical coordinate system design variable based on a radial distance and an angle, ris the radial distance, θ is a cylindrical coordinate system angle, PM is a permanent magnet, and R_{c} is a conversion reference radius.

The first to fourth steps are similar to those in the axial flux motor design variable verification method according to the embodiment of the present disclosure as described above, except that calculation is performed on the cylindrical coordinate system design variables of a plurality of virtual axial flux motors. In the method for optimizing the axial flux motor design variable according to the present aspect, the reason why the calculation is performed on the cylindrical coordinate system design variables of the plurality of virtual axial flux motors is that it may help to evaluate the efficiency and performance of theoretically possible motor design in consideration of various design scenarios. This may contribute to designers making better design decisions. In this process, it is possible to understand the effect of each design variable on the electromagnetic characteristics of the motor, and provide an opportunity to detect and correct unexpected design problems early. As a result, this optimization procedure may contribute to saving development time and cost and increasing the reliability of the final motor design.

In an embodiment, in the second step, the orthogonal coordinate system magnetic field may be derived from the orthogonal coordinate system design variable using the following equation (3):

$$∇ \cdot B = 0 \\ ∇ \times H = J \qquad ( 3 )$$

where B is magnetic flux density, H is a magnetic field strength, and J is a current density of a stator.

In one embodiment, the magnetic flux linkage may be derived based on the following equation (4):

$$∅ = \int B \cdot dA = \int ( ∇ \times A ) \cdot dA = ∮ A \cdot dl \qquad ( 4 )$$

where Φ is magnetic flux, B is magnetic flux density, A is a magnetic vector potential, and ∇×A is a magnetic vector potential curl.

In one embodiment, the counter electromotive force may be derived based on the following equation (5):

$$ε = - \frac{d ∅}{dt} = - \frac{d ∅}{{dy}_{r}} \frac{{dy}_{r}}{dt} = - v \frac{d ∅}{{dy}_{r}} \qquad ( 5 )$$

where ε is a counter electromotive force, τ is a time, yᵣ is a movement distance, and v is a velocity of a mover of the axial flux motor.

In an embodiment, the inductance may be derived based on the following equation (6):

$$L = ∅ I \qquad ( 6 )$$

where L denotes inductance of a stator of the axial flux motor, and I is a magnitude of current applied to the stator of the axial flux motor.

In an embodiment, the torque may be derived based on the following equation (7):

$$τ = {\int }_{{R}_{i}}^{{R}_{o}} {\int }_{- \frac{{θ}_{u}}{2}}^{\frac{{θ}_{u}}{2}} \frac{{B}_{θ} ( r , θ ) {B}_{z} ( {r}^{′} θ )}{{μ}_{0}} \cdot \hat{r} \cdot rdrd θ \approx {\sum }_{i = 1}^{M} {\sum }_{j = 1}^{N} \frac{{B}_{ij , θ} {B}_{ij , z}}{{μ}_{0}} \cdot \hat{{r}_{i}} \cdot {r}_{i} \frac{{θ}_{u}}{N} \frac{{R}_{o} - {R}_{i}}{M} \qquad ( 7 )$$

where τ is the torque, r is a radius as a variable, Rₒ is an outer radius as a constant, Rᵢ is an inner radius as a constant, θᵤ is a length in an angular direction of the axial flux motor as a constant, a subscript i is a position index in a radial direction, a subscript j is a position index in an angular direction, M is the number of lattices in a radial direction in a motor coordinate system, and N is the number of lattices in an angular direction in a motor coordinate system.

The fifth step may finally support optimal design selection by comparing and evaluating all possible motor designs through careful review of each design variable. By repeating this process, it is possible to check whether each motor design meets a given performance criterion, and exclude a design that does not meet the criterion. In addition, it may help to find the most efficient and economical solution among various design combinations.

The repetition in the fifth step may be executed while changing the design variable. The change of the design variable may be a random change, or may be based on a genetic algorithm using mutation and selection using the design variable itself or a gene for deriving the design variable, or may be another method, or may be based on a combination thereof. This process may help to explore and evaluate various design scenarios to maximize the efficiency and performance of the axial flux motor. Optimization techniques such as genetic algorithms may be used to identify strong candidates within a wide range of design spaces and ultimately provide cost-effective solutions. This iterative process is useful for discovering unexpected creative solutions or capturing important interactions that may be missed during the design process. Thus, this method may manage the complexity of motor design and contribute to deriving a motor design with better performance.

Hereinafter, an embodiment of the present disclosure will be described. However, the embodiments as described below are only some embodiments of the present disclosure, and the scope of the present disclosure is not limited to the following embodiments.

An electromagnetic analysis method according to an embodiment of the present disclosure is as follows. FIG. 2 is a diagram showing a state in which the shape of the iron core axial flux motor according to the present disclosure is converted. First, numerical information on the shape of the iron core axial flux motor is input to a cylindrical coordinate system, and the shape is converted into a shape corresponding to the orthogonal coordinate system as shown in FIG. 2. A magnetic permeability matrix is calculated based on the converted orthogonal coordinate system model, and a Maxwell matrix is constructed to derive a magnetic field in the motor stator. Electromagnetic data of the motor is calculated based on the calculated magnetic field, and the electromagnetic data includes motor force and magnetic flux linkage, and corresponding counter electromotive force and inductance. When the data is inversely converted back into the cylindrical coordinate system in the corresponding manner, the data on the iron core axial flux motor that was initially intended to be interpreted may be obtained.

The shape conversion proceeds through the coordinate conversion process of a following equation (2):

$$( {x}_{T} , {y}_{T} ) = ( {tan}^{- 1} ( \frac{x}{y} ) {R}_{c} , \sqrt{{x}^{2} + {y}^{2}} ) \qquad ( 2 )$$

In the equation (2) as set forth above, the reference radius R_{c} is derived under the condition that the force generation area of the axial flux motor before conversion and the force generation area of the orthogonal coordinate system motor after conversion are equal to each other. The reference radius R_{c} is is calculated as the average value of the outermost radius and the innermost radius of the axial flux motor. All axial flux motors follow the above rule in the conversion process. According to the equation (2), when the shape is converted from a cylindrical coordinate system to a orthogonal coordinate system, each of a back iron and a void is converted into a rectangular shape as indicated in the gray portion of FIG. 2, while each of an iron core and a permanent magnet is converted into an atypical shape which hardly represents a mathematically specific rule as indicated in the blue and red portions of FIG. 2. This problem may be solved by dividing each of the iron core and the permanent magnet into lattices of a specific size as shown in FIG. 3 and expressing the shape as a matrix of the equation (1) composed of 0 and 1. FIG. 3 is a diagram illustrating a conversion process in a coordinate system.

$${G}_{PM} ( r , θ ) = \{ \begin{matrix}1 ( PM existing point ) \\ 0 ( otherwise )\end{matrix} \qquad ( 1 )$$

In this way, the equation (1) is applied to the equation (3) as a magnetostatic Maxwell equation, such that the magnetic field about the shape of each of the iron core and the permanent magnet as converted into the atypical shape may be obtained.

$$∇ \cdot B = 0 \qquad ( 3 )$$

$$∇ \times H = J$$

In order to obtain the magnetic field of the cylindrical coordinate system based on the magnetic field derived from the orthogonal coordinate system, the magnetic field solution of the orthogonal coordinates is applied inversely to the equation (2) so as to correspond to the cylindrical system coordinates. Based on the magnetic field solution of the iron core axial flux motor as finally obtained, the magnetic flux linkage value may be derived using the equation (4), the counter electromotive force may be derived using the equation (5), and the inductance may be derived using the equation (6):

$$∅ = \int B \cdot dA = \int ( ∇ \times A ) \cdot dA = ∮ A \cdot dl \qquad ( 4 )$$

$$ε = - \frac{d ∅}{dt} = - \frac{d ∅}{{dy}_{r}} \frac{{dy}_{r}}{dt} = - v \frac{d ∅}{{dy}_{r}} \qquad ( 5 )$$

$$L = ∅ I \qquad ( 6 )$$

In addition, the torque may be calculated via a discrete integration process of the torque derived from the Maxwell stress tensor as shown in the equation (7):

$$τ = {\int }_{{R}_{i}}^{{R}_{o}} {\int }_{- \frac{{θ}_{u}}{2}}^{\frac{{θ}_{u}}{2}} \frac{{B}_{θ} ( r , θ ) {B}_{z} ( r , θ )}{{μ}_{0}} \cdot \hat{r} \cdot rd rd θ \approx {\sum }_{i = 1}^{M} {\sum }_{j = 1}^{N} \frac{{B}_{ij , θ} {B}_{ij , z}}{{μ}_{0}} \cdot {\hat{r}}_{i} \cdot {r}_{i} \frac{{θ}_{u}}{N} \frac{{R}_{o} - {R}_{i}}{M} \qquad ( 7 )$$

The r² term is included in the calculation process, which means that the torque generated from the external angle magnetic field is greater in proportion to the square of the radius than the torque generated from the internal angle magnetic field. This fact should be considered when optimizing the motor design variable in the orthogonal coordinate system and applying the optimizing result to the cylindrical coordinate system.

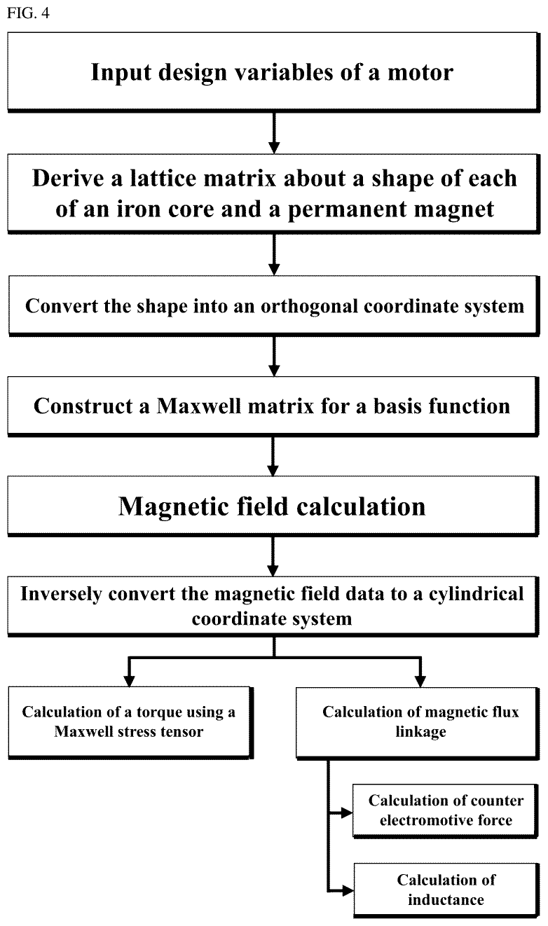

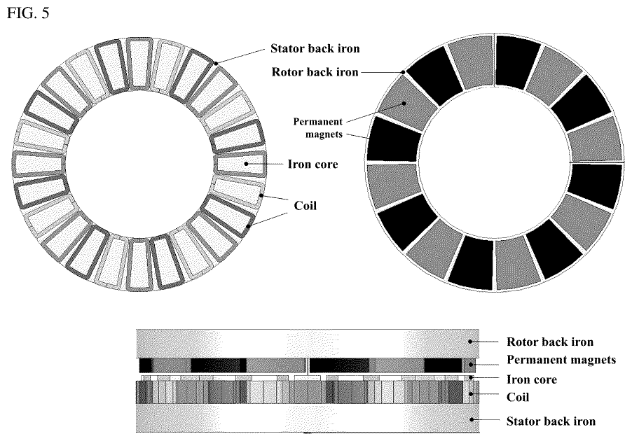

FIG. 4 shows a block diagram illustrating an electromagnetic analysis model according to the present disclosure. FIG. 5 illustrates an example of a motor according to an embodiment of the present disclosure.

Although the embodiments of the present disclosure have been described above with reference to the accompanying drawings, the present disclosure may not be limited to the embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that the embodiments as described above are not restrictive but illustrative in all respects.

What is claimed is:

1. A method for verifying an axial flux motor design variable, the method comprising:
a first step of converting a following equation (1) about a cylindrical coordinate system design variable of the axial flux motor into an orthogonal coordinate system design variable using a following equation (2);
a second step of deriving a orthogonal coordinate system magnetic field from the orthogonal coordinate system design variable;
a third step of deriving a cylindrical coordinate system magnetic field from the derived orthogonal coordinate system magnetic field using the following equation (2) in an inverse manner;
a fourth step of deriving one or more verification target physical quantities selected from a group consisting of magnetic flux linkage, counter electromotive force, inductance, and torque from the cylindrical coordinate system magnetic field; and
a fifth step of comparing the verification target physical quantity with a predetermined reference value and determining whether a verification condition thereon is achieved, based on the comparing result:
$${G}_{PM} ( r , θ ) = \{ \begin{matrix}1 & ( PM existing point ) \\ 0 & ( otherwise )\end{matrix} \qquad ( 1 )$$
$$( {x}_{T} , {y}_{T} ) = ( {tan}^{- 1} ( \frac{x}{y} ) {R}_{c} , \sqrt{{x}^{2} + {y}^{2}} ) \qquad ( 2 )$$
where G is a cylindrical coordinate system design variable based on a radial distance and an angle,
r is the radial distance,
θ is a cylindrical coordinate system angle,
PM is a permanent magnet,
R_{c} is a conversion reference radius.

2. The method of claim 1, wherein the second step includes deriving the orthogonal coordinate system magnetic field from the orthogonal coordinate system design variable using a following equation (3):
$$∇ \cdot B = 0 \qquad ( 3 )$$
$$∇ \times H = J$$
where B is magnetic flux density,
H is a magnetic field strength,
J is a current density of a stator.

3. The method of claim 1, wherein the magnetic flux linkage is derived based on a following equation (4):
$$∅ = \int B \cdot dA = \int ( ∇ \times A ) \cdot dA = ∮ A \cdot dl \qquad ( 4 )$$
where Φ is magnetic flux,
B is magnetic flux density,
A is a magnetic vector potential,
∇×A is a magnetic vector potential curl.

4. The method of claim 1, wherein the counter electromotive force is derived based on a following equation (5):
$$ε = - \frac{d ∅}{dt} = - \frac{d ∅}{{dy}_{r}} \frac{{dy}_{r}}{dt} = - v \frac{d ∅}{{dy}_{r}} \qquad ( 5 )$$
where ε is the counter electromotive force,
t is a time,
yᵣ is a movement distance,
v is a velocity of a mover of the axial flux motor.

5. The method of claim 1, wherein the inductance is derived based on the following equation (6):
$$L = ∅ I \qquad ( 6 )$$
where L denotes inductance of a stator of the axial flux motor,
I is a magnitude of current applied to the stator of the axial flux motor.

6. The method of claim 1, wherein the torque is derived based on a following equation (7):
$$τ = {\int }_{{R}_{i}}^{{R}_{o}} {\int }_{- \frac{{θ}_{u}}{2}}^{\frac{{θ}_{u}}{2}} \frac{{B}_{θ} ( r , θ ) {B}_{z} ( r , θ )}{{μ}_{0}} \cdot \hat{r} \cdot rd rd θ \approx {\sum }_{i = 1}^{M} {\sum }_{j = 1}^{N} \frac{{B}_{ij , θ} {B}_{ij , z}}{{μ}_{0}} \cdot {\hat{r}}_{i} \cdot {r}_{i} \frac{{θ}_{u}}{N} \frac{{R}_{o} - {R}_{i}}{M} \qquad ( 7 )$$
where τ is the torque,
r is a radius as a variable,
Rₒ is an outer radius as a constant,
Rᵢ is an inner radius as a constant,
θᵤ is a length in an angular direction of the axial flux motor as a constant,
a subscript i is a position index in a radial direction,
a subscript j is a position index in an angular direction,
M is the number of lattices in a radial direction in a motor coordinate system,
N is the number of lattices in an angular direction in a motor coordinate system.

7. A method for optimizing an axial flux motor design variable, the method comprising:
a first step of converting a following equation (1) about each cylindrical coordinate system design variable of each of two or more virtual axial flux motors into each orthogonal coordinate system design variable using a following equation (2);
a second step of deriving each orthogonal coordinate system magnetic field from each orthogonal coordinate system design variable;
a third step of deriving each cylindrical coordinate system magnetic field from each derived orthogonal coordinate system magnetic field using a following equation (2) in an inverse manner;
a fourth step of deriving each of one or more verification target physical quantities selected from the group consisting of magnetic flux linkage, counter electromotive force, inductance, and torque from each derived cylindrical coordinate system magnetic field; and
a fifth step of comparing each derived verification target physical quantity with a target design value, and selecting the virtual linear motor having the verification target physical quantity satisfying a target verification condition of the design variable among the two or more virtual axial flux motors, based on the comparing result,
wherein the method further comprises repeating the first to fifth steps at least one time on two or more virtual axial flux motors including the virtual axial flux motor selected in the fifth step:
$${G}_{PM} ( r , θ ) = \{ \begin{matrix}1 & ( PM existing point ) \\ 0 & ( otherwise )\end{matrix} \qquad ( 1 )$$
$$( {x}_{T} , {y}_{T} ) = ( {tan}^{- 1} ( \frac{x}{y} ) {R}_{c} , \sqrt{{x}^{2} + {y}^{2}} ) \qquad ( 2 )$$
where G is a cylindrical coordinate system design variable based on a radial distance and an angle,
r is the radial distance,
θ is a cylindrical coordinate system angle,
PM is a permanent magnet,
R_{c} is a conversion reference radius.

8. The method of claim 7, wherein the second step includes deriving the orthogonal coordinate system magnetic field from the orthogonal coordinate system design variable using a following equation (3):
$$∇ \cdot B = 0 \qquad ( 3 )$$
$$∇ \times H = J$$
where B is magnetic flux density,
H is a magnetic field strength,
J is a current density of a stator.

9. The method of claim 7, wherein the magnetic flux linkage is derived based on a following equation (4):
$$∅ = \int B \cdot dA = \int ( ∇ \times A ) \cdot dA = ∮ A \cdot dl \qquad ( 4 )$$
where Φ is magnetic flux,
B is magnetic flux density,
A is a magnetic vector potential,
∇>A is a magnetic vector potential curl.

10. The method of claim 7, wherein the counter electromotive force is derived based on a following equation (5):
$$ε = - \frac{d ∅}{dt} = - \frac{d ∅}{{dy}_{r}} \frac{{dy}_{r}}{dt} = - v \frac{d ∅}{{dy}_{r}} \qquad ( 5 )$$
where ε is the counter electromotive force,
t is a time,
yᵣ is a movement distance,
v is a velocity of a mover of the axial flux motor.

11. The method of claim 7, wherein the inductance is derived based on the following equation (6):
$$L = ∅ I \qquad ( 6 )$$
where L denotes inductance of a stator of the axial flux motor,
I is a magnitude of current applied to the stator of the axial flux motor.

12. The method of claim 7, wherein the torque is derived based on a following equation (7):
$$τ = {\int }_{{R}_{i}}^{{R}_{o}} {\int }_{- \frac{{θ}_{u}}{2}}^{\frac{{θ}_{u}}{2}} \frac{{B}_{θ} ( r , θ ) {B}_{z} ( r , θ )}{{μ}_{0}} \cdot \hat{r} \cdot rd rd θ \approx {\sum }_{i = 1}^{M} {\sum }_{j = 1}^{N} \frac{{B}_{ij , θ} {B}_{ij , z}}{{μ}_{0}} \cdot {\hat{r}}_{i} \cdot {r}_{i} \frac{{θ}_{u}}{N} \frac{{R}_{o} - {R}_{i}}{M} \qquad ( 7 )$$
where τ is the torque,
r is a radius as a variable,
Rₒ is an outer radius as a constant,
Rᵢ is an inner radius as a constant,
θᵤ is a length in an angular direction of the axial flux motor as a constant,
a subscript i is a position index in a radial direction,
a subscript j is a position index in an angular direction,
M is the number of lattices in a radial direction in a motor coordinate system,
N is the number of lattices in an angular direction in a motor coordinate system.
